(19) United States
(12) Patent Application Publication
(10) Pub. No.: US 2008/0096052 A1
(43) Pub. Date: Apr. 24, 2008

(54) METHOD OF TEXTURING SUBSTRATE FOR PERPENDICULAR MAGNETIC RECORDING MEDIA, TEXTURING DEVICE, AND PERPENDICULAR MAGNETIC RECORDING MEDIA

(75) Inventors: Hideki MATSUO, Matsumoto City (JP); Shoji SAKAGUCHI, Matsumoto City (JP); Hiroyuki NAKAMURA, Matsumoto City (JP)

Correspondence Address: ROSSI, KIMMS & McDOWELL LLP., P.O. BOX 826, ASHBURN, VA, 20146-0826, US

(73) Assignee: FUJI ELECTRIC DEVICE TECHNOLOGY CO., LTD., Tokyo (JP)

(21) Appl. No.: 11/877,634

(22) Filed: Oct. 23, 2007

(30) Foreign Application Priority Data
Oct. 24, 2006 (JP) 2006-288824

(51) Int. Cl. G11B 5/62; B24B 7/00

(52) U.S. Cl. 428/826; 451/177; 451/60

(57) ABSTRACT

A perpendicular magnetic recording media substrate, suitable for magnetic recording media using the perpendicular magnetic recording method, is disclosed. Texturing is used to polish the substrate. A polishing tape is pressed against a substrate, while a polishing slurry comprising abrasive particles is supplied onto the substrate for perpendicular magnetic recording media while it is rotated, to perform texturing of the substrate. The average fiber diameter of polishing fibers contained in the polishing tape is 400 nm or less, and the average particle diameter of abrasive particles contained in the polishing slurry is 150 nm or less.

### CROSS REFERENCE TO RELATED APPLICATIONS

This application claims priority from Japanese application Serial No. JP 2006-288824, filed on Oct. 24, 2006, the entire contents of which are incorporated herein by reference.

### BACKGROUND OF THE INVENTION

A. Field of the Invention

The present invention relates to a method and device for texturing substrates for perpendicular magnetic recording media, in which a polishing tape is pressed against the substrate for perpendicular magnetic recording media while supplying a polishing slurry comprising abrasive particles, as well as to perpendicular magnetic recording media comprising a substrate for perpendicular magnetic recording media which has been subjected to texturing.

B. Description of the Related Art

With the widespread adoption of digital appliances and similar devices in recent years, increases in the recording capacity of magnetic recording media (magnetic disks) have been sought. Presently a transition is underway to perpendicular magnetic recording to replace conventional longitudinal magnetic recording methods in order to realize higher recording densities leading to increased recording capacities. On the other hand, in order to realize high recording densities, the flying height of the magnetic head above the magnetic recording media surface during device operation must be decreased. In general, the flying height at which a magnetic head can fly while maintaining a stable distance from the magnetic recording media depends on the surface roughness of the magnetic recording media, and so it is necessary to reduce the surface roughness of the magnetic recording media in order to reduce the flying height of the magnetic head. Further, errors occurring during data reading and writing arise from anomalous damage (scratches and similar) on the surface of the magnetic recording media, and thus there is a need to prevent such damage from occurring.

When such magnetic recording media adopts the longitudinal magnetic recording method, for example, a substrate for magnetic recording media comprising an aluminum alloy base on which is formed a nonmagnetic layer such as a Ni—P plated film or similar is prepared. The surface of this substrate for magnetic recording media is polished, and a sputtering method or similar is used to form a magnetic layer, protective layer, and similar thereupon, to fabricate the magnetic recording media. For example, in magnetic recording media adopting the longitudinal magnetic recording method (hereafter “longitudinal magnetic recording media”), in order to facilitate magnetic orientation in the circumferential direction, and in order to prevent adhesion of the magnetic head to the surface of the magnetic recording media, machining is performed to form fine lines in the circumferential direction (texturing) on the surface of the substrate for longitudinal magnetic recording media.

Normally in texturing a disc-shaped substrate for longitudinal magnetic recording media is rotated while supplying a polishing slurry comprising diamond particles, alumina particles or similar, while pressing a polishing tape against the substrate surface. As a result, minute grooves are formed in the circumferential direction on the substrate surface. Because each of the layers formed on the substrate for longitudinal magnetic recording media is extremely thin, the surface shape of the longitudinal magnetic recording media can be said to be substantially determined by the texturing. The protrusions and depressions formed by texturing are substantially concentric, and affect the magnetic orientation of the magnetic layer formed thereafter. Hence the surface shape of the substrate for longitudinal magnetic recording media must be uniform and smooth (with little surface roughness).

It has been proposed that, in texturing of a substrate for longitudinal magnetic recording media, the diameters of particles in the polishing slurry be a prescribed size, or that the fiber diameters of the polishing fibers of the polishing tape be a prescribed thickness. For example, in Japanese Patent Laid-open No. 2004-259417 (corresponding to U.S. Patent Application Publication No. US 2004/0241379A1), technology is disclosed for obtaining a magnetic hard disk having fine texture marks, with a line density of 70 lines/μm. These are clearly formed on the surface of the magnetic hard disk substrate in the radial direction, without anomalous protrusions. To this end, a method is described in which a polishing slurry is provided in which are dispersed single-crystal diamond particles and polycrystalline diamond particles, with particle diameters in the range 1 to 50 μm. A polishing tape comprising such fibers as polyester fibers or nylon fibers of thickness in the range 0.1 to 5 μm is pressed while running over the substrate surface, so that texturing of the substrate surface is performed.

Further, in Japanese Patent Laid-open No. 2005-329534, a polishing cloth is disclosed with a single fiber diameter of 1 to 250 nm, to be used as a polishing cloth for texturing so as to render smooth a hard disk surface. And, in Japanese Patent Laid-open No. 2003-170348, a polishing cloth is disclosed as a polishing base cloth used in texturing, fabricated by applying, to a base material comprising fiber bundles of 20 or more extremely fine fibers of average diameter 0.05 to 2 μm, a polyalkylene oxide solution or fluid paraffin emulsion dispersing element, and then performing fiber raising.

However, in the case of magnetic recording media employing a perpendicular magnetic recording method in which the magnetic orientation is perpendicular (hereafter “perpendicular magnetic recording media”), if there are texture marks in the circumferential direction, magnetic orientation occurs in this direction, and so it is difficult to obtain the low-noise characteristic required for magnetic recording. In general, in perpendicular magnetic recording media, when the substrate surface is planar, magnetic noise is reduced and magnetic orientation in the perpendicular direction is more easily obtained. Hence the use of a polishing treatment to polish the surfaces of substrates, in order to improve the smoothness of perpendicular magnetic recording media, has for example been disclosed in Japanese Patent Laid-open No. 2005-216465 and Japanese Patent Laid-open No. 2005-149603.

However, when fabricating perpendicular magnetic recording media, the use of a texturing treatment has also been proposed. For example, Japanese Patent Laid-open No. 2004-296059 (corresponding to U.S. Patent Application Publication No. US 2004/0234819A1) states that after texturing of the soft magnetic underlayer surface of a substrate for perpendicular magnetic recording media using free particles, minute defects due to random scratches and similar, which inevitably exist on the surface of the soft magnetic underlayer as a result of the polishing process, can be avoided by then forming layers in succession thereupon by sputtering. Japanese Patent Laid-open No. 2006-092715 discloses that in perpendicular magnetic recording media having at least a backing layer and a perpendicular magnetic recording film on a non-magnetic substrate, by texturing the surface of the nonmagnetic substrate a plurality of grooves along the substrate radial direction are formed.

As described above, the use of texturing with substrates for longitudinal magnetic recording media, limiting the particle diameters of particles in the polishing slurry, or limiting the fiber diameters of polishing fibers in the polishing tape, has been proposed. However, such technologies do not examine or stipulate which combinations of what kinds of polishing slurries and polishing tapes are suitable for use in texturing substrates for perpendicular magnetic recording media.

Hence an object of this invention is to study the conditions for texturing of substrates for perpendicular magnetic recording media, and to obtain perpendicular magnetic recording media substrates suitable for use with perpendicular magnetic recording media. The present invention is directed to overcoming or at least reducing the effects of one or more of the problems set forth above.

### SUMMARY OF THE INVENTION

In order to attain these and other objects, a method of texturing a substrate for perpendicular magnetic recording media of this invention is a method in which, while supplying a polishing slurry containing abrasive particles onto a rotating substrate for perpendicular magnetic recording media, a polishing tape is pressed thereagainst and texturing of the substrate for perpendicular magnetic recording media is performed, and is characterized in that the average diameter of polishing fibers contained in the polishing tape is 400 nm or less, and that the average particle diameter of abrasive particles contained in the polishing slurry is 150 nm or less.

Further, in order to attain the above object, a device for texturing a substrate for perpendicular magnetic recording media of this invention is characterized in comprising rotation support means for rotatably supporting the substrate for perpendicular magnetic recording media; pressing means for pressing a polishing tape having polishing fibers of average diameter 400 nm or less against the substrate for perpendicular magnetic recording media rotatably supported by the rotation support means; and supply means for supplying polishing slurry comprising abrasive particles having an average particle diameter of 150 nm or less to the portion of contact of the polishing tape, which is pressed by the pressing means, with the substrate for perpendicular magnetic recording media supported rotatably by the rotation support means.

In the above invention, it is preferable that the diameters of polishing fibers contained in the polishing tape be 200 nm±40 nm, and that the average particle diameter of abrasive particles contained in the polishing slurry be 50 nm or greater. Further, it is desirable that the texturing be performed on a soft magnetic layer of the substrate for perpendicular magnetic recording media.

This invention further relates to perpendicular magnetic recording media comprising the above-described substrate for perpendicular magnetic recording media. By means of this invention, a perpendicular magnetic recording media substrate which is suitable for perpendicular magnetic recording media can be obtained.

### BRIEF DESCRIPTION OF THE DRAWINGS

The foregoing advantages and features of the invention will become apparent upon reference to the following detailed description and the accompanying drawings, of which:

FIG. 1 is a conceptual schematic cross-sectional view of a portion of a substrate for perpendicular magnetic recording media, as an example;

FIG. 2 shows in summary the configuration of principal portions of the texturing device of an aspect;

FIG. 3 is a summary side view of the texturing device of FIG. 2;

FIG. 4 is a drawing used to explain operation of the texturing device of FIG. 2;

FIGS. 5A and 5B are graphs which plot the surface roughness of perpendicular magnetic recording media obtained by texturing, when the average fiber diameter of polishing fibers comprised by the polishing tape and the average particle diameter of abrasive particles in the polishing slurry are each varied;

FIGS. 6A and 6B are graphs which plot the tip radius of substrates for perpendicular magnetic recording media obtained by texturing, when the average fiber diameter of polishing fibers in the polishing tape and the average particle diameter of abrasive particles in the polishing slurry are each varied;

FIG. 7 is a graph which plots the number of defects occurring in polishing of the surface of substrates for perpendicular magnetic recording media;

FIG. 8 is a graph which plots the number of scratches occurring in texturing of the surface of substrates for perpendicular magnetic recording media;

FIG. 9 is a graph which plots the test pass rate obtained in glide height tests of perpendicular magnetic recording media fabricated using textured substrates and polished substrates; and,

FIG. 10 is a graph plotting the SNR of perpendicular magnetic recording media fabricated using textured substrates and polished substrates.

### DETAILED DESCRIPTION OF SPECIFIC EMBODIMENTS

Below, aspects of the invention are explained based on the drawings. First, a substrate for perpendicular magnetic recording media, hereafter substrate 10, is subjected to texturing and used in fabricating perpendicular magnetic recording media, as explained. After texturing of substrate 10, a Cr film or other nonmagnetic metal underlayer, Co alloy magnetic film or other magnetic recording film, and amorphous carbon film or other protective layer can be deposited in order by sputtering or another method. Then, by applying a liquid lubricant thereupon, a lubrication layer is formed, to complete fabrication of the perpendicular magnetic recording media.

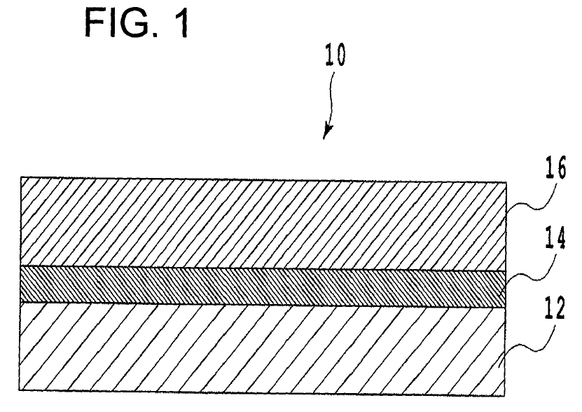

FIG. 1 is a partial cross-sectional schematic view of the outside in the radial direction, from the center hole, of disk-shaped substrate 10. Substrate 10 is structured by stacking, in order, nonmagnetic base 12, initial reaction layer 14, and soft magnetic underlayer 16.

As nonmagnetic base 12, an aluminum alloy can be used. However, reinforced glass or crystallized glass can also be used to fabricate nonmagnetic base 12; or, polycarbonate, polyolefin, or another plastic resin may be injection-molded to fabricate base 12.

As initial reaction layer 14 provided on nonmagnetic base 12, a Zn film layer, formed by immersing in a zincate solution (a solution comprising zinc oxide and caustic soda aqueous solution), is used. In general, initial reaction layer 14 is subjected to activation treatment by alternating immersion in an acidic tin chloride solution and in acidic palladium chloride solution to cause precipitation of Pd nuclei. Initial reaction layer 14 can also be fabricated from Ni, Ni—P, Cu, Cr, Fe, Pd, or similar by sputtering or by ion plating or another physical adsorption method.

As soft magnetic underlayer 16 deposited onto initial reaction layer 14, a Ni—P layer formed by electroless plating is used. In substrate 10 of this aspect, this Ni—P layer is deposited using an electroless plating method, for reasons of low cost and compatibility with volume production. However, the Ni—P layer can also be fabricated using another well-known film deposition method, such as sputtering, ion plating, or another physical adsorption method, according to the characteristics required. Moreover, soft magnetic underlayer 16 is not limited to a Ni—P layer, but may be fabricated from another material. Soft magnetic underlayer 16 corresponds to the soft magnetic layer in the invention.

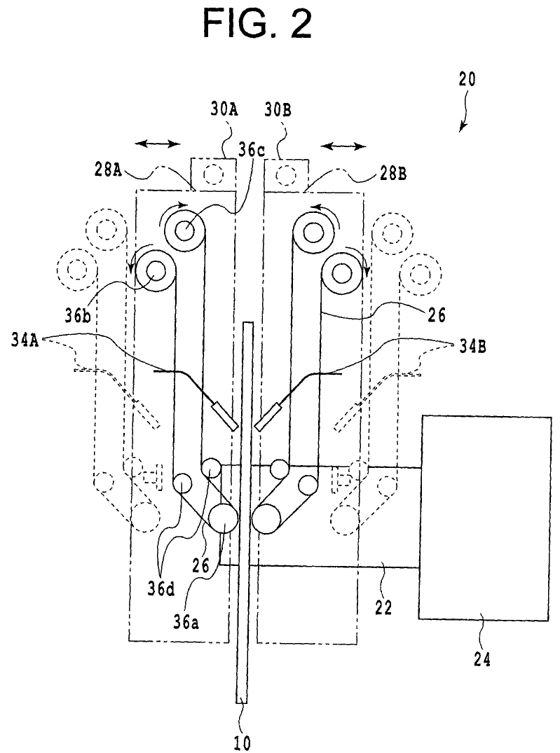

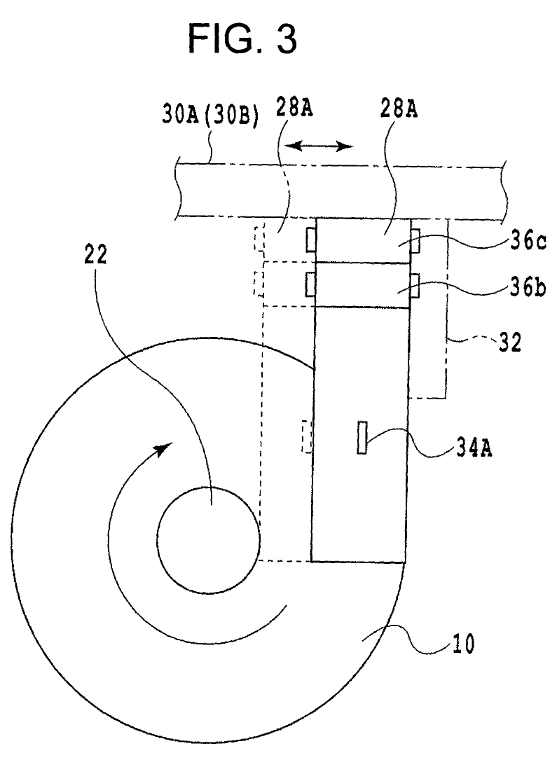

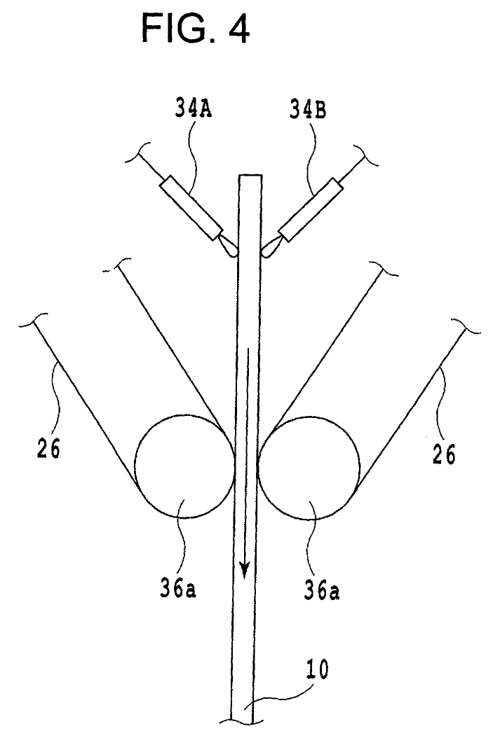

Next, texturing device 20 to polish the surface of substrate 10 is explained. FIG. 2 shows in summary texturing device 20 of this aspect, showing the principal portions thereof. FIG. 3 shows in summary a side view of texturing device 20 of FIG. 2. And, FIG. 4 is used to explain operation of the texturing device shown in FIG. 2.

Texturing device 20 comprises chuck mechanism 22, which detachably holds disk-shaped substrate 10 having a center hole; rotation driving portion 24, linked to chuck mechanism 22, which causes chuck mechanism 22 to rotate together with substrate 10; tape polishing mechanisms 28A and 28B, which respectively hold portions of polishing tape 26 against surfaces of the substrate 10 to be machined; tape polishing mechanism feed devices 30A and 30B, which cause tape polishing mechanisms 28A and 28B to mutually approach or recede along the center axis line of chuck mechanism 22; oscillation device 32, which causes tape polishing mechanisms 28A and 28B to simultaneously move in the radial direction of substrate 10; and polishing slurry providing portions 34A and 34B, which provide polishing slurry (slurry liquid) to the surfaces of substrate 10 to be machined. The rotation support means of this invention comprises chuck mechanism 22 and rotation driving portion 24; the pressing means of this invention comprises tape polishing mechanisms 28A and 28B; and the supply means of this invention comprises polishing slurry providing portions 34A and 34B.

Chuck mechanism 22, positioned on a center axis line common with the hole in substrate 10, holds substrate 10 such that the flat surfaces of substrate 10 intersect the center axis line at substantially right angles. Rotation driving portion 24 is for example a driving motor, which in this aspect is capable of causing rotation of substrate 10 and chuck mechanism 22 in the range of approximately 50 to 500 rpm.

Tape polishing mechanisms 28A and 28B, which are placed in opposition to enclose substrate 10, have the same construction. Hence tape polishing mechanism 28A is here explained, and an explanation of tape polishing mechanism 28B is omitted.

Tape polishing mechanism 28A comprises a feed-out roller 36c, which feeds out polishing tape 26, described below; take-up roller 36b, which takes up polishing tape 26; pressing roller 36a, which presses a portion of the continuously fed polishing tape 26 against the surface of substrate 10 to be machined; and tensioner roller 36d, which applies a tension force to the portion of polishing tape 26 between pressing roller 36a and feed-out roller 36c, and to the portion taken up between pressing roller 36a and take-up roller 36b. Take-up roller 36b is linked to the output shaft of a driving motor, not shown. By this means, when the driving motor is in the operating state, polishing tape 26 fed out from feed-out roller 36c moves in the direction indicated by the arrows in FIG. 2, past pressing roller 36a, to be taken up by take-up roller 36b continuously at a prescribed speed. Hence during texturing, a new portion of the continuously fed polishing tape 26 which is wrapped about the outer surface of pressing roller 36a travels while making constant contact with the surface of substrate 10 to be machined. Further, tape polishing mechanisms 28A and 28B are provided with polishing slurry providing portions 34A and 34B, which provide polishing slurry to the surfaces of substrate 10 to be machined.

Polishing slurry providing portions 34A and 34B are positioned within tape polishing mechanisms 28A and 28B, respectively, such that the tips thereof face the surfaces to be machined of substrate 10. Hence as shown in enlargement in FIG. 4, polishing slurry providing portions 34A and 34B are positioned in mutual opposition enclosing substrate 10. Polishing slurry providing portions 34A and 34B are moveable with respect to tape polishing mechanisms 28A and 28B respectively.

In performing texturing, tape polishing mechanisms 28A and 28B first are moved along the center axis line direction of substrate 10 by tape polishing mechanism feed devices 30A and 30B respectively, from standby positions retracted from the surfaces to be machined of substrate 10 (the positions indicated by broken lines in FIG. 2) to polishing execution positions (the positions indicated by the solid lines in FIG. 2). Next, tape polishing mechanisms 28A and 28B are moved in a radial direction of substrate 10 by oscillation device 32, as shown in FIG. 3. At this time, tape polishing mechanisms 28A and 28B each cause a portion of polishing tape 26 to be pressed against and rub against the surface to be machined of substrate 10 as shown in FIG. 4. Also at this time, polishing slurry is provided to the rubbed portions from polishing slurry providing portions 34A and 34B.

Next, after texturing of the entire surfaces to be machined of substrate 10, the supply of polishing slurry from polishing slurry providing portions 34A and 34B is halted. Then, operation of tape polishing mechanisms 28A and 28B is stopped, and tape polishing mechanisms 28A and 28B are returned to the standby positions, retracted from the surfaces to be machined of substrate 10 by tape polishing mechanism feed devices 30A and 30B. Substrate 10 for which texturing has been completed is removed from chuck mechanism 22, and is transferred to processes to form the magnetic recording layer and other layers.

Below, specific embodiments of texturing of substrates 10 and comparison examples are explained.

In texturing device 20 with the above-described configuration, the fiber diameters of the polishing fibers of polishing tape 26 and the particle diameters of the abrasive particles in the polishing slurry were varied, and polishing, that is, texturing, of substrates 10 was performed. The results are explained below. Here substrates 10 subjected to texturing were polished in advance under prescribed conditions, until the surface shape had reached a prescribed level.

As polishing tape 26, a sheet-shape polishing cloth comprising polishing fibers having nanometer-order diameters was used. More specifically, a polishing tape comprising nylon fibers (nanofibers) the average fiber diameter of which was approximately 200 nm, with diameters in the range 200 nm±40 nm, was used. In addition, polishing tape comprising nylon fibers with fiber diameters in the range 700 nm±50 nm and with an average fiber diameter of approximately 700 nm, as well as polishing tape comprising nylon fibers with fiber diameters in the range 1500 nm±120 nm and with an average fiber diameter of approximately 1500 nm (1.5 μm), were also used, and the results of texturing using these tapes were compared. These polishing fibers substantially consisted of nylon.

Further, as the polishing slurry, slurry in which are dispersed abrasive particles having nanometer-order particle diameters is used. More specifically, as the abrasive particles, diamond particles having an average particle diameter of 50 nm, and more precisely, diamond clusters having an average cluster size of 50 nm, are used; these are dispersed in an alkaline surfactant and prepared in slurry form for use as the polishing slurry. In addition, a polishing slurry in which diamond particles of average particle size 100 nm were dispersed in an alkaline surfactant, and a polishing slurry in which diamond particles of average particle size 150 nm were dispersed in an alkaline surfactant, were also used, and the results of texturing using these were compared.

During testing, substrate 10 was rotated at 300 rpm, polishing tape 26 was fed at 20 mm/min and was pressed against the substrate with a pressure of 10 kgf/cm², and texturing of substrate 10 was performed either continuously or intermittently for 20 seconds. The oscillation amplitude of polishing tape 26 during texturing was 4 mm, and the oscillation cycle rate was 415 cycles/min (6.9 Hz).

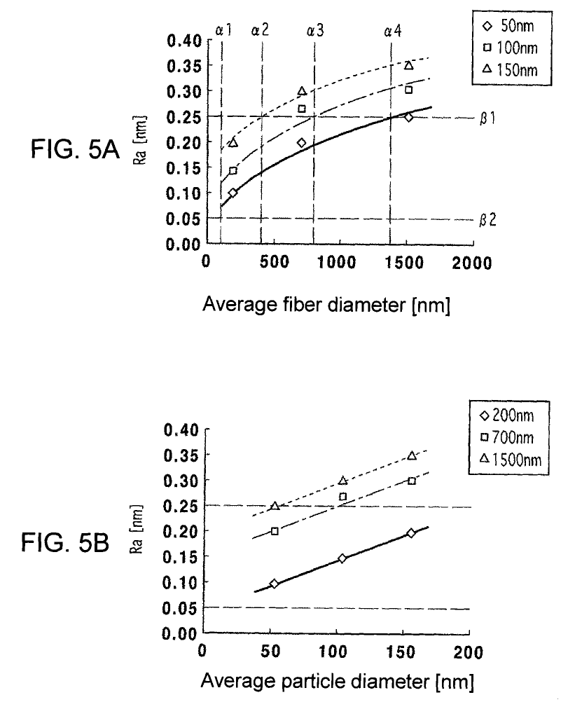

In the graph of FIG. 5, the surface roughness (center-line average roughness Ra (units: nm) of substrates 10 obtained by performing texturing is shown, while varying the average fiber diameter of the polishing fibers in the polishing tape 26 and the average particle diameter of abrasive particles in the polishing slurry. FIG. 5A shows the average fiber diameter of polishing fibers along the horizontal axis and the surface roughness of substrate 10 along the vertical axis. In FIG. 5B, the horizontal axis indicates the abrasive particle average diameter, and the vertical axis indicates the surface roughness of substrate 10. The same results as in FIG. 5A are shown, focusing on differences in the average fiber diameter of polishing fibers comprised by polishing tape 26.

In order to reduce the flying height of the magnetic head to an extent compatible with perpendicular magnetic recording, while preventing adhesion of the magnetic head to the perpendicular magnetic recording media, it is preferable that the surface roughness Ra of substrate 10 be 0.15±0.10 nm (0.05 nm to 0.25 nm). Substrates 10 with surface roughness in this range were obtained in all cases in which texturing was performed with the average fiber diameter of polishing fibers comprised by polishing tape 26 equal to 200 nm, and with the average particle diameter of abrasive particles in the polishing slurry at 50 nm, 100 nm, or 150 nm. Substrates 10 having such a surface roughness were also obtained when texturing was performed with the average fiber diameter of polishing fibers comprised by polishing tape 26 at 700 nm, and with the average particle diameter of abrasive particles in the polishing slurry equal to 50 nm. Hence it was made clear that performing texturing using polishing tape 26 comprising polishing fibers having such average fiber diameters, and using a polishing slurry comprising abrasive particles having such average particle diameters, is suitable for polishing of substrate 10.

The line α1 in FIG. 5A crosses the horizontal axis at an average fiber diameter of 100 nm, and the line α2 crosses the horizontal axis at an average fiber diameter of 400 nm. Focusing on line α2 and on line β1 which crosses the vertical axis at a surface roughness Ra of 0.25 nm, by performing texturing of substrate 10 with the average fiber diameter of polishing fibers comprised by polishing tape 26 at 400 nm and the average particle diameter of abrasive particles in the polishing slurry at 150 nm, it is inferred that the surface roughness Ra of substrate 10 can be made equal to or less than the 0.25 nm set as the value currently enabling use in perpendicular magnetic recording media. And, focusing on the line α1 and on the line β2 which crosses the vertical axis at a surface roughness Ra of 0.05 nm, by performing texturing of substrate 10 with the average fiber diameter of polishing fibers comprised by polishing tape 26 at 100 nm and the average particle diameter of abrasive particles in the polishing slurry at 50 nm, it is inferred that the surface roughness Ra of substrate 10 can be made the low value of approximately 0.05 nm. Hence, when the average particle diameter of abrasive particles in the polishing slurry is from 50 nm to 150 nm, if the average fiber diameter of polishing fibers comprised by polishing tape 26 is made 100 nm or greater but 400 nm or less and texturing of substrate 10 is performed, a substrate with surface roughness Ra of 0.15±0.10 nm can be obtained.

Further, in FIG. 5A, focusing on line α3 which crosses the horizontal axis at an average fiber diameter of 800 nm and on line β1, by performing texturing of substrate 10 with the average fiber diameter of polishing fibers comprised by polishing tape 26 at 800 nm and with the average particle diameter of abrasive particles in the polishing slurry at 100 nm, it is inferred that there are cases in which the surface roughness Ra of substrate 10 can be made 0.25 nm or less. Hence when the average particle diameter of abrasive particles in the polishing slurry is made from 50 nm to 100 nm, by texturing substrate 10 with the average fiber diameter of polishing fibers comprised by polishing tape 26 at 100 nm or higher but 800 nm or lower, it is thought that substrate 10 with a surface roughness Ra of 0.15±0.10 nm can effectively be obtained.

Further, focusing on line α4 which crosses the horizontal axis at the average fiber diameter of 1400 nm and on line β1 in FIG. 5A, by performing texturing of substrate 10 with the average fiber diameter of polishing fibers comprised by polishing tape 26 at 1400 nm and with the average particle diameter of abrasive particles in the polishing slurry at 50 nm, it is inferred that the surface roughness Ra of substrate 10 can be made 0.25 nm or less. Hence when the average particle diameter of abrasive particles in the polishing slurry is made 50 nm, by texturing substrate 10 with the average fiber diameter of polishing fibers comprised by polishing tape 26 at 100 nm or higher but 1400 nm or lower, it is thought that substrate 10 with a surface roughness Ra of 0.15±0.10 nm can be obtained.

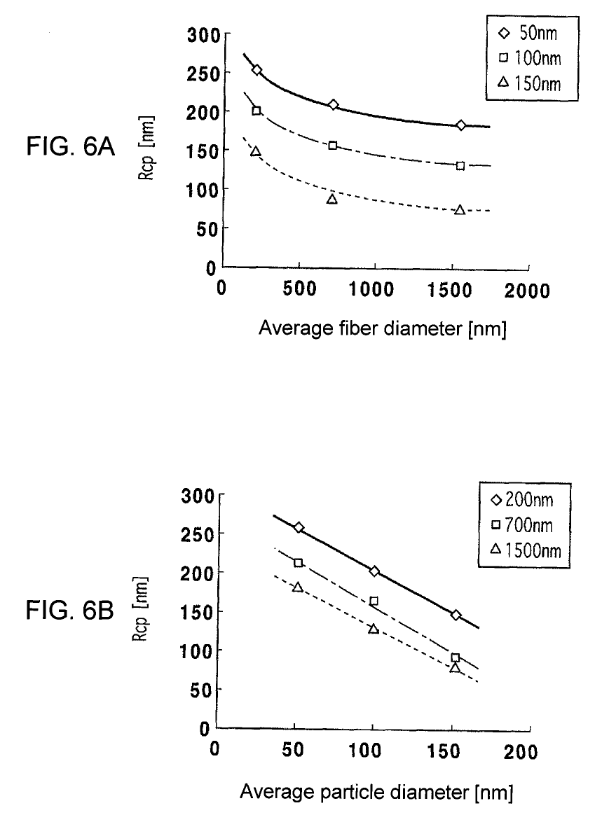

Next, the graph of FIG. 6 shows tip radii (Rcp) (units: nm) of the surfaces of substrates 10 when texturing is performed while varying the average fiber diameter of polishing fibers of polishing tape 26 and the average particle diameter of abrasive particles in the polishing slurry. In FIG. 6A, the horizontal axis indicates the average fiber diameter of polishing fibers, and the vertical axis indicates the tip radius of substrate 10; results are displayed which focus on differences in the average particle diameters of abrasive particles in the polishing slurry. In FIG. 6B, the average particle diameter of abrasive particles is indicated by the horizontal axis and the tip diameter of substrate 10 is taken along the vertical axis. The same results as in FIG. 6A are shown, focusing on differences in average fiber diameters of polishing fibers in the polishing tape 26.

Here the “tip radius” is used to quantitatively compare the shapes of the tips of protrusions in the surfaces of substrates 10 formed by texturing, and indicates the sharpness (roundness) of the tips of protruding portions. More specifically, the tip radius indicates the radius of the circle when the tip outline of a protruding portion on the surface of substrate 10 is approximated by a circle. From the graph of FIG. 6 it is seen that the narrower the average fiber diameter of polishing fibers comprised by polishing tape 26, or the smaller the average particle diameter of abrasive particles comprised by the polishing slurry, the larger the tip radii of the protruding portions on the surface of substrate 10 which is obtained.

In general, the tip radius is correlated with the ratio of magnetization values (OR-Mrt) in the circumferential direction and in the radial direction of substrate 10; the larger the tip radius, the lower the magnetic susceptibility ratio. The ratio of magnetization values indicates the extent to which magnets on the magnetic recording media are aligned in the circumferential direction. In the case of longitudinal magnetic recording media, signals are written so as to cause minute magnets to be arranged in the longitudinal direction (that is, the circumferential direction), and so it is preferable that magnets be aligned neatly in the circumferential direction. However, in the case of perpendicular magnetic recording, signals are written with minute magnets arranged in the perpendicular direction, and so if magnets are aligned in the circumferential direction, they become a source of noise, and the electromagnetic transducing characteristic is degraded. Hence it is desirable that tip radii on the surface of substrate 10 for perpendicular magnetic recording be large, and that the ratio of magnetization values be low. Here, the above results are taken into consideration, according to which the narrower the average fiber diameter of polishing fibers in polishing tape 26, and the smaller the average particle diameter of abrasive particles in the polishing slurry, the larger is the tip radius of substrate 10 obtained. As a result, it is clear that texturing using polishing tape 26 with polishing fibers the average fiber diameter of which is approximately 200 nm, and using polishing slurry comprising abrasive particles having an average particle diameter of 50 nm to 150 nm, is appropriate for polishing the surface of substrate 10 for use in perpendicular magnetic recording media.

Next, results are compared for substrates which have been textured after the above-described polishing (textured substrates) and for substrates subjected only to polishing (polished substrates). Here, the average particle diameter of abrasive particles in the polishing slurry used in texturing was 100 nm.

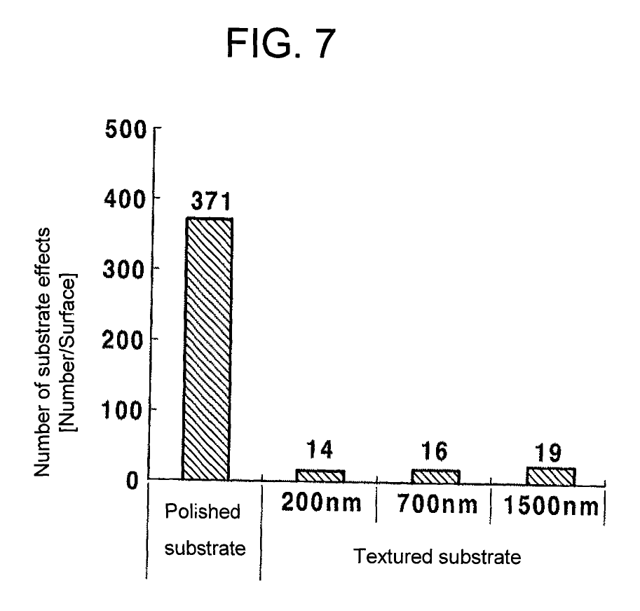

FIG. 7 shows the number of defects arising from polishing of the substrate surface (hereafter “number of substrate defects”) (units: number/surface). Even when texturing is performed using polishing tape comprising nanofibers with average fiber diameters of 200 nm and 700 nm, and when texturing is performed using polishing tape comprising nanofibers with an average fiber diameter of 1500 nm (1.5 μm), it is seen that by performing texturing the number of substrate defects is greatly reduced.

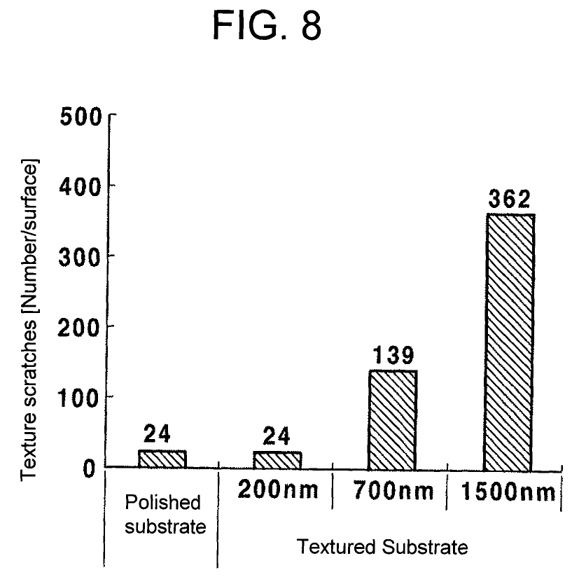

On the other hand, from the graph showing the number of scratches arising from texturing on the substrate surface (hereafter “texturing scratches”) (units: number/surface) in FIG. 8, it is seen that when a polishing tape was used having microfibers with an average fiber diameter of 1500 nm (1.5 μm), there were numerous texturing scratches, and clear texture marks were formed on the substrate. On the other hand, when texturing was performed using polishing tape 26 with nanometer-order fibers, and in particular 200 nm nanofibers, only approximately the same scratching as on substrates subjected to polishing alone without texturing was observed, and it became clear that only very slight texture marks were formed. That is, by performing texturing using polishing tape 26 comprising polishing fibers with an average fiber diameter of approximately 200 nm, not only can defects arising from polishing be eliminated, but also the formation of scratches arising from texturing can be suppressed.

Using both textured substrates which had been textured using a polishing slurry comprising abrasive particles of average particle diameter 100 nm, as well as polished substrates which had been subjected to polishing only, perpendicular magnetic recording media were fabricated by depositing thereupon a nonmagnetic metal underlayer, magnetic recording layer, and protective layer in order, and then forming a lubricating layer on top, as described above. Then, the perpendicular magnetic recording media was subjected to glide height tests, and test pass rates (GHT) were determined (as percentages).

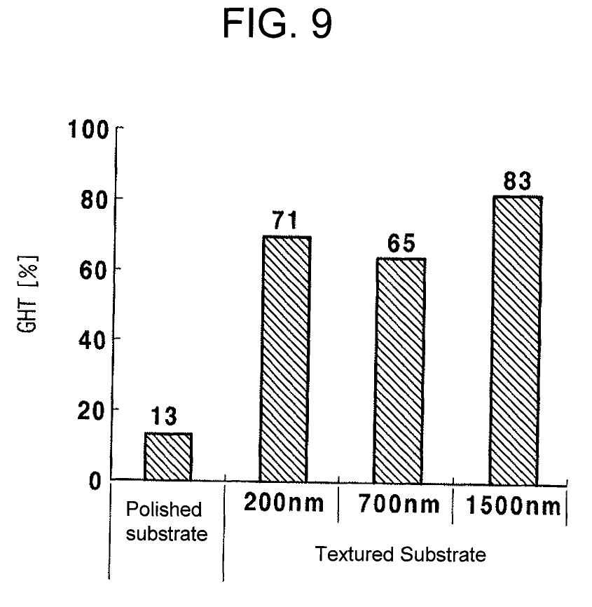

Results are shown in FIG. 9. Glide height tests are tests in which a head for inspection is caused to fly above the surface of perpendicular magnetic recording media, seeking on the perpendicular magnetic recording media is performed, and inspections for the occurrence of anomalous protrusions at the surface are performed A Hitachi DECO tester RQ7800 was used in measurements. In the case of perpendicular magnetic recording media which employed polished substrates, there were numerous occurrences of anomalous protrusions arising from polishing, collisions with the head, and crashes due to head flying instability, so that the pass rate was poor. On the other hand, in the case of perpendicular magnetic recording media which employed textured substrates, excellent pass rates were obtained. This indicates that by subjecting substrates 10 to texturing, anomalous protrusions due to polishing can be eliminated, and the minute protrusions and depressions formed in the circumferential direction by texturing enable stable head flight.

Next, the SNR (Signal-to-Noise Ratio) (units: dB), which is the ratio of the signal output to noise for perpendicular magnetic recording media, was investigated for the above-described perpendicular magnetic recording media, fabricated using textured substrates and using polished substrates.

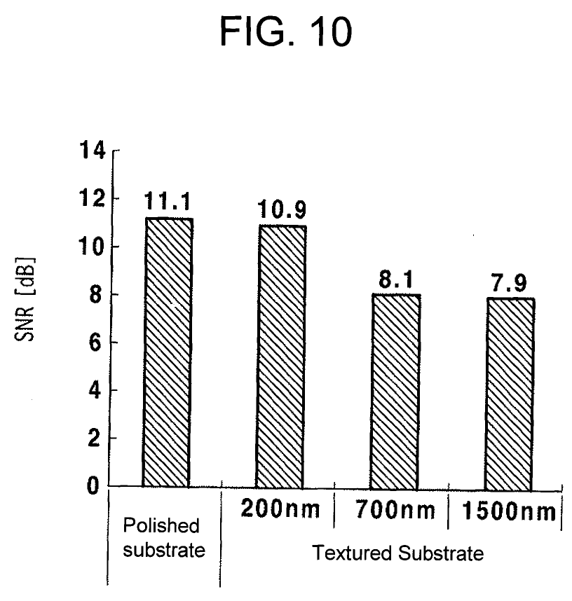

Results appear in FIG. 10. A higher SNR was obtained from perpendicular magnetic recording media using a substrate obtained by performing texturing using polishing tape comprising nanofibers with an average fiber diameter of 200 nm than from perpendicular magnetic recording media using substrates obtained by texturing using polishing tape comprising fibers with an average fiber diameter of 1500 nm or 700 nm. This SNR was substantially the same as the SNR of perpendicular magnetic recording media obtained using a polished substrate, and is a satisfactory value for perpendicular magnetic recording media. From the above it is clear that when texturing substrates for use in perpendicular magnetic recording media, by using polishing tape 26 comprising nanofibers with an average fiber diameter of approximately 200 nm, perpendicular magnetic recording media can be obtained in which head flying stability is secured through minute protrusions and depressions in the circumferential direction, and moreover satisfactory electromagnetic transducing characteristics are obtained.

From the above it is seen that texturing is extremely effective for polishing of substrates 10, and that by performing texturing, a substrate having a more uniform and flat surface shape, suitable for perpendicular magnetic recording media, can be obtained. In particular, it has become clear that, in the above-described texturing device 20, it is extremely effective to perform texturing of the surface of substrate 10 using polishing tape 26, pressed against and running over the surface of substrate 10, the average fiber diameter of the polishing fibers in which is substantially 200 nm, and with an average particle diameter of the abrasive particles dispersed in the polishing slurry supplied from polishing slurry providing portions 34A and 34B equal to 50 nm or greater but 150 nm or less.

In the above, the invention has been explained based on aspects; but the invention is not limited to these aspects. Substrate 10 which is to be textured by a texturing device for perpendicular magnetic recording media substrates of this invention may have any other configuration if the substrate is to be used in perpendicular magnetic recording media, and further polishing may also be performed in advance. Also, texturing devices 20 are not limited to the above-described configuration, but may adopt various other forms. And, the polishing fibers and similar of polishing sheets may be formed from other materials, and the abrasive particles of the polishing slurry may be of other material, such as for example single-crystal diamond or polycrystalline diamond. The polishing fibers of the polishing sheet may be fabricated using the technology disclosed in Japanese Patent Laid-open No. 2005-325494, or by another method.

In the above aspects, the invention was explained with a certain degree of specificity. However, it should be understood that various modifications and improvements can be made without deviating from the spirit or scope of the invention as disclosed in the claims. That is, the invention comprises the scope of the attached claims and inventions equivalent thereto, as well as various modifications and alterations thereto.

Thus, a method of texturing substrate for perpendicular magnetic recording media, texturing device, and perpendicular magnetic recording media has been described according to the present invention. Many modifications and variations may be made to the techniques and structures described and illustrated herein without departing from the spirit and scope of the invention. Accordingly, it should be understood that the methods and apparatus described herein are illustrative only and are not limiting upon the scope of the invention.

### FIG. 5

### Average Fiber Diameter (Nm)

### Average Particle Diameter (Nm)

### FIG. 6

### Average Fiber Diameter (Nm)

### Average Particle Diameter (Nm)

### FIG. 7

### Number of Substrate Defects (Number/Surface)

### Polished Substrate

### Textured Substrate

### FIG. 8

### Texture Scratches (Number/Surface)

### Polished Substrate

### Textured Substrate

### FIG. 9

### Polished Substrate

### Textured Substrate

### FIG. 10

### Polished Substrate

Textured Substrate

What is claimed is:

1. A method of texturing a substrate for perpendicular magnetic recording media, comprising:
supplying onto a rotating substrate for perpendicular magnetic recording media a polishing slurry containing abrasive particles having an average particle diameter of 150 nm or less, and
pressing against said rotating substrate a polishing tape having an average diameter of polishing fibers of 400 nm or less, so that the polishing slurry textures the substrate.

2. The method of texturing a substrate for perpendicular magnetic recording media according to claim 1, wherein the diameter of polishing fibers contained in the polishing tape is 200 nm±40 nm, and the average particle diameter of abrasive particles contained in the polishing slurry is 50 nm or greater.

3. The method of texturing a substrate for perpendicular magnetic recording media according to claim 1, wherein the texturing is performed on a soft magnetic layer of the substrate for perpendicular magnetic recording media.

4. A device for texturing a substrate for perpendicular magnetic recording media, comprising:
a rotation support for rotatably supporting a substrate for perpendicular magnetic recording media;
a polishing tape having polishing fibers of average diameter 400 nm or less;
a polishing slurry supply comprising abrasive particles having an average particle diameter of 150 nm or less; and
a pressing device which presses said polishing tape against the substrate as it is being rotated by the rotation support means, with the polishing slurry provided from said polishing slurry supply being between said polishing tape and said substrate.

5. A device for texturing a substrate for perpendicular magnetic recording media, comprising:
rotation support means for rotatably supporting a substrate for perpendicular magnetic recording media;
pressing means for pressing a polishing tape having polishing fibers of average diameter 400 nm or less against the substrate for perpendicular magnetic recording media rotatably supported by the rotation support means; and
supply means for supplying polishing slurry, comprising abrasive particles having an average particle diameter of 150 nm or less, to a portion of contact of the polishing tape, which is pressed by the pressing means, with the substrate for perpendicular magnetic recording media supported rotatably by the rotation support means.

6. The device for texturing a substrate for perpendicular magnetic recording media according to claim 5, wherein the diameter of polishing fibers contained in the polishing tape is 200 nm±40 nm, and the average particle diameter of abrasive particles contained in the polishing slurry is 50 nm or greater.

7. The device for texturing a substrate for perpendicular magnetic recording media according to claim 5, wherein the texturing is performed on a soft magnetic layer of the substrate for perpendicular magnetic recording media.

8. A perpendicular magnetic recording medium, comprising a substrate that has been textured with a polishing slurry containing abrasive particles having an average particle diameter of 150 nm or less and a polishing tape having an average diameter of polishing fibers of 400 nm or less.
